(19) United States
(12) Patent Application Publication
(10) Pub. No.: US 2007/0251057 A1
(43) Pub. Date: Nov. 1, 2007

(54) FURNITURE HINGE

(75) Inventor: Horst Lautenschlager, Reinheim (DE)

Correspondence Address: CARLSON, GASKEY & OLDS, P.C., 400 WEST MAPLE ROAD, SUITE 350, BIRMINGHAM, MI, 48009, US

(73) Assignee: LIBERTY HARDWARE MFG. CORP., Winston-Salem, NC (US)

(21) Appl. No.: 11/737,158

(22) Filed: Apr. 19, 2007

(30) Foreign Application Priority Data
Apr. 26, 2006 (DE) 102006019268.0

(51) Int. Cl. E05F 1/14

(52) U.S. Cl. 16/284

(57) ABSTRACT

An example furniture hinge a door fitting including a recessed cup, a hinge pin, a carrier arm, and a hinge knuckle adjacent said hinge pin and pivotably attaching the carrier arm to an interior portion of said recessed cup. At least two spring legs extend from at least two spring coils and press against a cam on either side of the hinge knuckle. The spring legs have a first portion outside the recessed cup and a second portion supported by the recessed cup. A spring bow joins the spring legs and is positioned outside the recessed cup. A retaining pin extending from the recessed cup holds each of the spring legs, and a surface of said recessed cup supports the spring coils.

This application claims priority to German Patent Application No. 10 2006 019 268.0 filed on Apr. 26, 2006.

### BACKGROUND OF THE INVENTION

This invention relates to a furniture hinge. More particularly, this invention relates to a furniture hinge having a door fitting in the form of a recessed cup with a carrier arm pivotably mounted within the recessed cup, in which two spring legs extending from a coil spring outside the recessed cup and supported by the recessed cup, press against a cam on either side of a hinge knuckle.

Some known furniture hinges, such as the type described in U.S. Pat. No. 5,617,612, accommodate two spring coils and two spring legs extending from the spring coils on a common axis inside the recessed cup. A spring bow, supported by the inner surface of the recessed cup, joins the two opposing ends of the two spring coils. The recessed cup accommodates the entire spring. If not covered by a cover plate, the spring is accessible and visible from the inner side of the furniture door. The interior portion of the recessed cup accommodating the spring can become dirty and is difficult to clean. Further, the visible arrangement of the spring is considered aesthetically obtrusive.

Other known furniture hinges include the two spring coils on the non-visible exterior of the recessed cup. Only the two spring legs that bear against the cams on the hinge knuckle of the carrier arm extend through openings into the interior space of the recessed cup. The two spring coils are accommodated and pivot at either end of a common pin that extends crosswise through the recessed cup. A separate support leg extends from each spring coil and is supported at the recessed cup. The separate support leg transmits the force required for pre-tensioning of the spring coil against the recessed cup. Only the pin carrying and securing the spring coil prevents tipping the spring coil. As the internal diameter of the spring coil changes as a consequence of spring movement, exact placement of the spring coil on the bearing pin is difficult. Also, assembly and securing of the two spring parts is also difficult.

It would be desirable to design a furniture hinge that is simple to assemble and in which the spring components in their assembled state are retained simply and reliably in their predetermined position.

### SUMMARY

An example furniture hinge a door fitting including a recessed cup, a hinge pin, a carrier arm, and a hinge knuckle adjacent said hinge pin and pivotably attaching the carrier arm to an interior portion of said recessed cup. At least two spring legs extend from at least two spring coils and press against a cam on either side of the hinge knuckle. The spring legs have a first portion outside the recessed cup and a second portion supported by the recessed cup. A spring bow joins the spring legs and is positioned outside the recessed cup. A retaining pin extending from the recessed cup holds each of the spring legs, and a surface of said recessed cup supports the spring coils.

Another example furniture hinge includes two spring coils joined together by a spring bow located outside the recessed cup. Each connecting leg extending from each spring coil of the spring bow engages a retaining pin extending from the recessed cup. The two spring coils are supported at their outer ends by a support surface of the recessed cup.

### BRIEF DESCRIPTION OF DRAWINGS

The various features and advantages of this disclosure will become apparent to those skilled in the art from the following detailed description. The drawings that accompany the detailed description can be briefly described as follows:

FIG. 1 shows a cross-sectional side view of an example furniture hinge in a closed position;

FIG. 2 shows a front view of the example furniture hinge;

FIG. 3 shows an example spring from the example furniture hinge.

### DETAILED DESCRIPTION

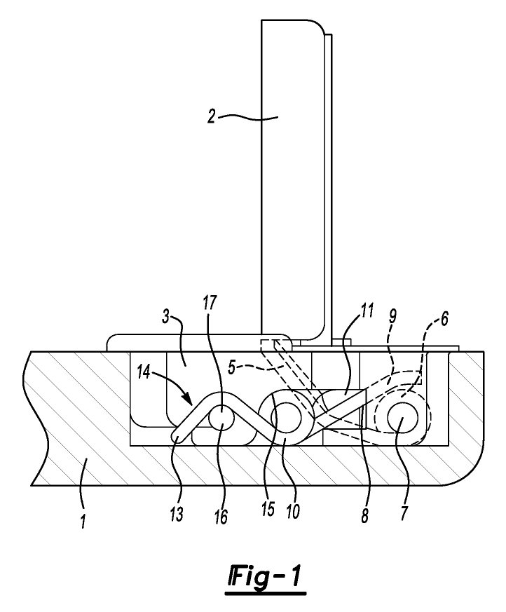

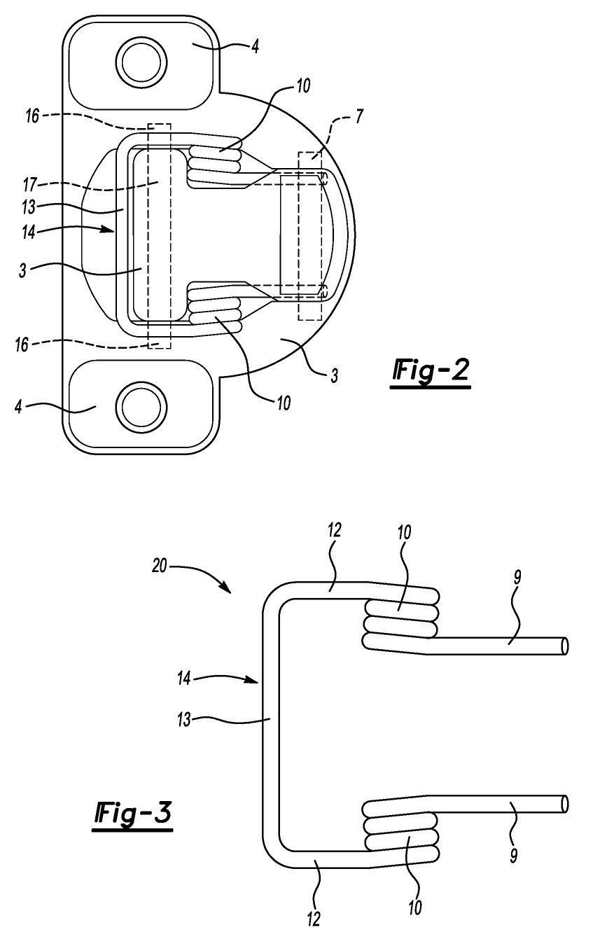

The example furniture hinge shown in FIGS. 1 and 2 serves for the pivotable attachment of a furniture door 1 to a piece of furniture. For example, the example furniture hinge pivotably attaches the furniture door 1 to a furniture front frame 2 of a piece of having a “face-frame” design.

The furniture hinge includes a door fitting that, in this example, is a recessed cup 3 attached to the furniture door 1 with screws securing a pair of attachment ears 4 on the sides of the recessed cup 3.

A carrier arm 5 attaches and pivotably connects to the front frame 2 by a hinge knuckle 6 with a hinge-pin axis 7 within the recessed cup 3. The carrier arm 5 is formed from sheet-metal, for example.

The hinge knuckle 6 includes a pair of cams 8 form on opposing sides of the hinge knuckle 6. A pair of spring legs 9, extending from a spring coil 10 located externally to the recessed cup 3, are biased against each of the cams 8. The spring legs 9 extend from one of the spring coils 10 through an opening 11 to the interior of the recessed cup 3.

The spring legs 9 press against the cams 8 so that the furniture door 1 is held in either a closed position (FIG. 1) or an open position.

The two spring coils 10 are generally aligned with one another and lie on opposing sides of the recessed cup 3. The spring legs 9 pressing against the cams 8 extend from the opposing inner ends of the aligned spring coils 10. The opposing, outer ends of the spring coils 10 include a pair of connecting legs 12 joined by a common connecting member 13 to form a spring bow 14.

The spring bow 14 lies outside the recessed cup 3. The spring coils 10 forming the spring bow 14 are supported in pretensioned condition with their outer sides each against a support surface 15 of the recessed cup 3.

A retaining pin 16 extending from the recessed cup 3 holds the connecting legs 12 extending from each of the spring coils 10. The connecting legs 12 are bent such that the connecting member 13 of the spring bow 14 lies against the lower exterior of the recessed cup 3. Each retaining pin 16 extends from opposite sides of the recessed cup 3 and aligns with one another. A retaining rod 17 passing through the recessed cup 3 forms the retaining pin 16.

Referring now to FIG. 3 with continuing reference to FIGS. 1 and 2, A spring component 20 comprises the spring coils 10, the spring legs 9, the connecting legs 12, the connecting member 13, and the spring bow 14. The spring leg 9 and the supporting leg 12 each extend from the bottom side of the spring coils 10, the side away from the support surface 15.

Each of the two aligned spring coils 10, which are supported by the support surface 15 without the use of any internal pin or the like in this example, include three complete spring turns. During assembly of the spring component, the required spring pretension is obtained when the connecting member 13 of the spring bow 14 is urged into the position shown in FIG. 1. The spring component maintains this pretensioned position by introduction of the retaining rod 17, the two ends of which form the retaining pins 16 for the support leg 12.

The open interior of the recessed cup 3, which is visible from the inner side of the door, is practically free of all obtrusive components. Only the ends of the spring legs 9 extend through the opening 11 into the interior and the retaining rod 17 extends crosswise through the interior of the recessed cup 3.

The example furniture hinge 10 provides a particularly simple and advantageous one-piece design for manufacturing and assembly. Further, preponderate portions of the spring component 20 are outside the recessed cup 3 and thus are not visible and not accessible from the inner side of door 1.

The example furniture hinge 10 includes the advantageous one-piece spring component 20, combined with the advantages of the spring coils 10 being located outside the recessed cup 3.

The example furniture hinge 10 is advantageous in that the support by the recessed cup 3 to provide spring pretensioning takes place, first, on the outer ends of the spring coil 10 and, second, by means of retaining pins 16 extending from the recessed cup 3.

In another example furniture hinge 10, the two retaining pins 16, extending from opposite sides of the recessed cup 3 and aligned with one another, consist of the retaining rod 17 extending through the recessed cup 3. The connecting member 13 and spring bow 14 connecting the two spring coils 10 presses against the underside of the recessed cup 3 and the retaining rod 17 is positioned crosswise into the recessed cup 3 to support the connecting legs 12 of the spring bow 13 to pretension the spring during assembly.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

I claim:

1. A furniture hinge, comprising:
a door fitting including a recessed cup;
a hinge pin;
a carrier arm;
a hinge knuckle adjacent said hinge pin and pivotably attaching said carrier arm to an interior portion of said recessed cup;
at least two first spring legs each extending from at least two spring coils and pressing against a cam on either side of said hinge knuckle, said at least two first spring legs having a first portion outside said recessed cup and a second portion supported by said recessed cup; and
a spring bow joining said at least two first spring legs and positioned outside said recessed cup, wherein a retaining pin extending from said recessed cup holds each of said at least two first spring legs, and a surface of said recessed cup supports said at least two spring coils.

2. The furniture hinge of claim 1, wherein each of said retaining pin protruding from opposing sides of said recessed cup are formed by ends of a common retaining rod extending through said recessed cup.

3. The furniture hinge according to claim 1, including at least two second spring legs each extending from facing inner ends of said at least two spring coils and each pressing against said cam.

4. The furniture hinge of claim 3, wherein said at least two first spring legs extend from opposing outer ends of said spring coil.

5. The furniture hinge of claim 4, wherein said at least two spring legs extend from an outer side of said at least two spring coils, said outer side located away from said surface of said recessed cup.
